(19) United States
(12) Patent Application Publication
(10) Pub. No.: US 2022/0139359 A1
(43) Pub. Date: May 5, 2022

(54) Fade Away Radius For Stringed Musical Instrument

(71) Applicant: Lance Robert McCormick, Chatsworth, CA (US)

(72) Inventor: Lance Robert McCormick, Chatsworth, CA (US)

(73) Assignee: Lance Robert McCormick, Chatsworth, CA (US)

(21) Appl. No.: 17/087,263

(22) Filed: Nov. 2, 2020

(51) Int. Cl. G10D 1/08; G10D 3/06

(52) U.S. Cl. CPC G10D 1/08; G10D 3/06

(57) ABSTRACT

Ergonomic improvement for stringed musical instrument arrived at though the creation of a multi plane body; or neck body joining; that causes the repositioning of instrument's neck finger board radius crown in relation to performers body reducing curvature of wrist, extension of tendons, and effort required to fret notes.

### FIELD OF INVENTION

This invention is for guitars, basses, and all stringed musical instruments consisting of a body, neck, and plurality of strings under tension, yields for performing artist an ergonomically improved instrument.

### BACKGROUND OF INVENTION

The modern electric guitar and bass are stringed musical instruments based off symphonic string instruments and the acoustic “gut string” guitar, all such instruments have in common, a neck that protrudes from body with plurality of strings under tension. The performing surface of neck that the strings are depressed against to sound individual pitches; or collectively chords, is called “the fingerboard”. It has long been the standard luthiery norm to manufacture a radius on said fingerboard, edge to edge, for the entire longitudinal length for ergonomic reasoning, to allow for bow movement on symphonic string instruments and to match the curvature of the performing artist's hand. Additionally the finger board radius has always been engineered with a topography positioning the highest vertical elevation of radius (radius crown) in the center of latitudinal width for longitudinal entirety in relationship to the face of instrument body. That constructional technique results in the requirement of the performing artist's fingerboard appendage, wrist, fingers, and related tendons to exert the greatest force and extension to reach across entire longitudinal width of neck's finger board to depress for sounding the largest gauge strings.

### SUMMARY OF INVENTION

Therefore it is the ergonomic intention of this design improvement to reduce the effort required for the performing artist to depress single notes and chords on a stringed musical instrument neck by reducing the effort required to depress said notes and chords which in turn increases the potential for self expression and reduces the potential for appendage fatigue.

This invention resulted from the realization that creating a multi plane instrument body would reposition the neck's finger board radius crown in relation to performers torso creating ergonomic conditions that reduce fingerboard appendage muscles and related tendons required amount of contraction due to the reduced wrist and finger curvature needed for sounding the strings; particularly the largest gauge lowest pitch strings; requiring the furthest extension across entire longitudinal width of fingerboard and greatest force to actuate.

One method of Fade Away Radius creation is via the neck mounting cavity of a two piece solid body electric guitar or bass; a common current production technique made popular by Fender Musical Instrument Co. in the 1950's; often referred to as a “slab guitar” or “paddle guitar”; a mass production technique in which the instrument body and neck are fabricated separately then attached through a neck mounting cavity mortised into the body face. The neck and body are joined via four screws and a rectangular metal neck plate positioned on back of body which acts as a washer for the neck and it's retaining screws; mortising said neck mounting cavity with a “tilt” in relation to instrument body face so that the neck mounts at an angle sufficient enough to cause the fingerboard's highest elevation in relation to body face to be positioned along the entire longitudinal edge of neck's fingerboard; the edge in closest proximity with largest gauge lowest pitch string; the remaining surface area of finger-board gradually “fades away” reducing in elevation in relationship to the instrument body face, or as the performing artist moves there hand finger tips from largest gauge lowest pitch string downward across latitudinal width of finger board toward smaller gauge higher pitch strings.

Another methods for creating the Fade Away Radius neck condition is though instrument body construction via, lamination, sculpture, carving, mortising, router, CNC fabrication, or any other method that results in the stringed musical instrument having a neck/body relationship that results in the most elevated topographical portion of neck fingerboard radius to be located along the outer most longitudinal edge of neck associated with largest gauge string and in closest proximity with performers shoulder when instrument is played in a standard sitting or standing position.

### DISCLOSURE OF PREFERRED EMBODIMENT

Other objects, features, and advantages will occur from the following description of the preferred embodiment and the accompanying drawings, in which:

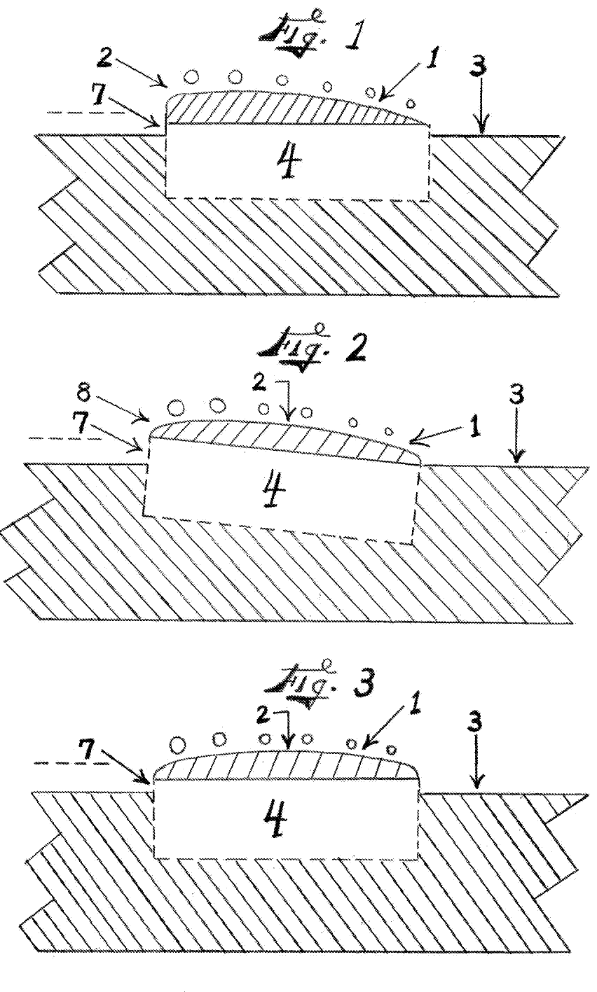

FIG. 1 Is across-sectional view of standard guitar body and neck joint taken along line 2-2 of FIG. 4. demonstrating standard neck 4, mounting cavity 7, in body 3, with re-positioned finger-board radius crown 2. The Fade Away Radius 1, is created by the addition of material to latitudinal duration of the finger-board on the side associated with largest gauge string and in closest proximity to performers shoulder.

FIG. 2 Is a cross-sectional view taken along line 2-2 of FIG. 4, demonstrates standard center finger-board crown 2, neck 4, with body 3, mounting cavity 7, excavated at angle to body face 3, creating Fade Away Radius 1, repositioned radius crown 8.

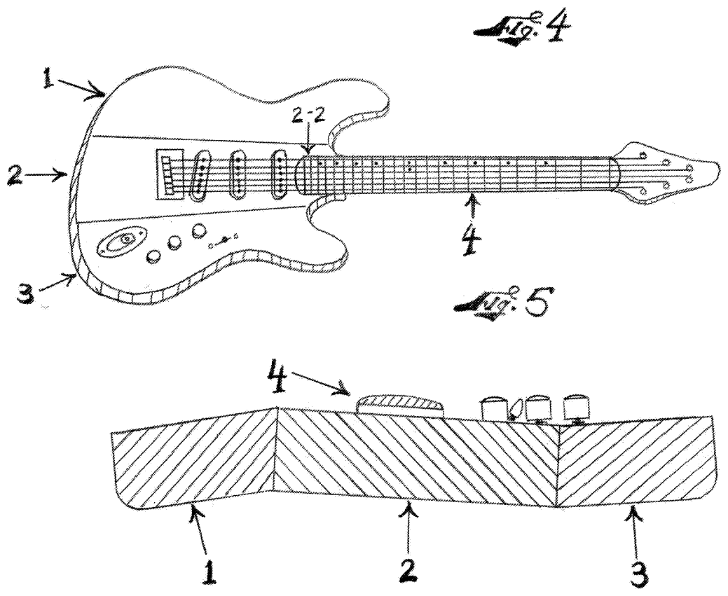

FIG. 3 Is across-sectional view taken along line 2-2 of FIG. 4, demonstrates standard neck mounting, creating center finger-board crown 2, finger board radius contour 1, neck 4, body 3, neck cavity 7

FIG. 4 Demonstrates six string electric guitar body constructed via three sections 1,2,3 creating Fade Away Radius.

FIG. 5 Demonstrates end view of guitar in FIG. 4. Fade Away Radius 4, created by opposing angles of body wings, 1 and 3, connecting to body center 2.

FIG. 4 and FIG. 5 Demonstrates a method of creating Fade Away Radius through instrument body construction. Additional ergonomic comfort is obtained via concave portion created on back of body by angled joining of 1, and 2, in FIG. 5. The triangulation of body center section 2, in FIG. 4 when joined by 1, and 3, creates further ergonomic comfort for performing artist when instrument is held against body in standard performance position. Center of body 2, in FIG. 4 utilizes FIG. 3 standard neck 4, body 3, joint 7. Fade Away Radius of FIG. 4 and FIG. 5 is created by opposing angles of body wings 1, and 3. The production advantage demonstrated in FIG. 5 is the employment of a standard center crown finger board 2, neck 4, due to the readily available supple of such necks. In addition the three piece body construction of FIG. 4 and FIG. 5 is a production advantage due to the reduced size of lumber required to manufacture.

1. A stringed musical instrument, be it acoustically amplified or electrically, consisting of a resonating body; a neck having a elongated longitudinal section inset within at least the upper boundary of said body and a suspended plurality of strings under tension over said neck fingerboard performance surface where in; the performance surface; fingerboard, fret-board; has a latitudinal radius with forward most protruding portion positioned along upper longitudinal edge, the longitudinal edge in closest proximity to performer's head and shoulder of finger board appendage when instrument is held; by said performer; in a traditional performance position.

2. A stringed musical instrument, be it acoustically amplified or electrically, consisting of a resonating body; a neck having a elongated longitudinal section inset within at least the upper boundary of said body and a suspended plurality of strings under tension over said neck fingerboard performance surface where in; the performance surface; fingerboard, fret-board; has a latitudinal radius with forward most protruding portion in relationship to performer's torso positioned along the upper longitudinal edge of guitar neck for duration of its length when held in tradition performance position.

3. A stringed musical instrument, be it acoustically amplified or electrically, consisting of a resonating body; a neck having a elongated longitudinal section inset within at least the upper boundary of said body and a suspended plurality of strings under tension over said neck fingerboard performance surface where in; the performance surface; fingerboard, fret board; has a latitudinal radius with upper most elevation positioned along upper longitudinal edge due to the shape of instrument body and how it conforms to performers torso.

4. A stringed musical instrument as in claim 1 in which the body of instrument is constructed of multiple pieces of flat wood in a longitudinal direction angularly joined so that when positioned against performers torso; while performer is in a standing position; the portion of neck's latitudinal fingerboard radius that is furthest in distant from performers torso is positioned in tandem with largest gauge lowest pitch string and the portion of neck's latitudinal fingerboard radius that is closest in proximity to performers torso is positioned in tandem with smallest gauge highest pitch string for longitudinal duration.

5. A stringed musical instrument as in claim 1, in which the body of instrument is carved, molded, formed, and or contoured in such a manner as to create the ergonomic condition when positioned against performers torso; while standing in a performance position; so that the neck's latitudinal fingerboard radius along upper most longitudinal edge; edge associated with largest gauge lowest pitch string; will be situated at the greatest distant from performers torso; and the lower most longitudinal edge; edge associated with smallest gauge highest pitch string; will be reversely the closest in proximity to performers torso for longitudinal duration of latitudinal neck radius.

6. A stringed musical instrument as in claim 1, in which the body of instrument is carved, molded, formed, and or contoured in such a manner as to create the ergonomic condition when placed against performers torso while in tradition standing performance position so that the instrument's neck latitudinal fingerboard radius will assume a condition which places the upper most longitudinal edge at the greatest distance from performers torso and the lower most longitudinal edge in closest proximity to performers torso for duration of necks longitudinal length.

7. A stringed musical instrument as in claim 1, in which the body of instrument is carved, molded, formed, and or contoured in such a manner that when held in performance position; the upper most longitudinal edge of neck finger-board playing surface protrudes beyond any other latitudinal point of the neck finger-board playing surface for longitudinal duration.

8. A stringed musical instrument as in claim 1 in which the body of instrument is carved, molded, formed, and or contoured in such a manner that when held in performance position; the lower most longitudinal edge of neck finger-board playing surface is receded below any other latitudinal point of the neck finger-board playing surface for longitudinal duration.

9. A stringed musical instrument as in claim 1, that has a neck fingerboard playing surface with radius crown positioned along upper longitudinal edge, edge in association with largest gauge lowest pitch string; creating an ergonomic benefit that is arrived at through the neck body joining cavity, body construction, or any combination of those elements that result in said radius crown positioning.

10. A stringed musical instrument as in claim 1, with neck body relationship generating ergonomic improvement for performing artist through the reduction of wrist curvature required in depressing largest gauge strings which are in closest proximity to their shoulder and the upper longitudinal edge of instrument neck when held in the traditional performance position; standing or sitting.

11. A stringed musical instrument as in claim 1 that utilizes a three piece latitudinal adhesion body fabrication method; where in the pieces are joined at angular seams which cause instrument's neck to have largest gauge string positioned over the most elevated portion of the neck finger board radius for longitudinal duration when instrument is held by performer in a standing position.

12. A stringed musical instrument as in claim 1 in which the body of instrument is carved, molded, formed, and or contoured in such a manner that when held in a standing performance position the most vertically elevated portion of neck finger board latitudinal radius is associated with largest gauge string and said elevation gradually reduces in correspondence with reduction of remaining string gauges.
